(19) United States
(12) Patent Application Publication
(10) Pub. No.: US 2026/0124847 A1
(43) Pub. Date: May 7, 2026

(54) PROTECTIVE CASE

(71) Applicant: Board Boys, LLC, Spring, TX (US)

(72) Inventors: Lawrence LEE, Spring, TX (US); Andrew LUY, New York, NY (US); Eric JOHANSON, Rocklin, CA (US); Wei Yu, Jiangsu (CN)

(21) Appl. No.: 19/480,726

(22) PCT Filed: May 8, 2024
(86) PCT No.: PCT/CN2024/091736

§ 371 Date: Oct. 31, 2025

Related U.S. Application Data
(60) Provisional application No. 63/464,877, filed on May 8, 2023.

(51) Int. Cl. B42D 3/06; B42D 3/10; B42F 7/02

(52) U.S. Cl. CPC B42D 3/06; B42D 3/10; B42F 7/025

(57) ABSTRACT

Described herein is a capsule (1000) comprising a front cover (1100) having a front wall (1110) having a front wall top edge (1112), a first side wall (1120) having a first side wall extension (1122), a second side wall (1130) having a second side wall extension (1132), and a bottom wall (1140), where both the first and the second side walls extensions (1122, 1132) extend beyond the front wall top edge (1112) relative to the bottom wall(1140), the capsule (1000) further comprises a back cover (1200) coupled to the front cover (1100) having a back wall (1210) and a top wall (1250), where the back wall (1210) includes a recess hinge (1212), where a portion of the back wall (1210) above the position of the hinge (1212) and the top wall (1250) are configured as a back flap (1214), and where the coupled front and back covers (1100, 1200) define a capsule interior.

### BACKGROUND

Protection of collectibles, such as comic books, is a preferred method for ensuring longevity of condition and value. However, conventional protection suffers from an inadequate balance of security and accessibility. That is, as conventional protection devices increase in security, there is a corresponding decrease in accessibility to the protected item, and vice versa. As many of these protected items are intended to be viewed or otherwise enjoyed, conventional protective cases are inadequate.

Therefore, there is a need for improved protective cases.

### SUMMARY

A capsule comprising a front cover having a front wall having a front wall top edge, a first side wall having a first side wall extension, a second side wall having a second side wall extension, and a bottom wall, where both the first and the second side walls extensions extend beyond the front wall top edge relative to the bottom wall, and where the front wall is comprised of a uniformly substantially transparent, non-translucent, and non-colored material. The capsule further comprises a back cover coupled to the front cover having a back wall and a top wall, where the back wall includes a recess hinge, where a portion of the back wall above the position of the hinge and the top wall are configured as a back flap, and where the coupled front and back covers define a capsule interior. The front cover and the back cover below the hinge are configured to be coupled together using associated coupling tabs and coupling slots. The front cover at each of the side wall extensions and the back flap at the top wall are configured to be coupled together using a coupling nipple and an associated nipple recess. The capsule is configured such that an interior of the capsule is accessible when the back flap at the top wall is decoupled with the front cover at each of the side wall extensions while the front cover and the remained of the back cover are coupled together below the hinge.

In another example, A capsule comprises a front cover having a front wall having a front wall top edge, a first side wall having a first side wall extension, a second side wall having a second side wall extension, and a bottom wall, where both the first and the second side walls extensions extend beyond the front wall top edge; a back cover coupled to the front cover having a back wall and a top wall, where the back wall includes a recess hinge, where a portion of the back wall above the position of the hinge and the top wall are configured as a back flap, and where the coupled front and back covers define a capsule interior; wherein the front cover and the back cover below the hinge are configured to be coupled together using associated coupling tabs and coupling slots, wherein the front cover at each of the side wall extensions and the back flap at the top wall are configured to be coupled together, and wherein the capsule is configured such that an interior of the capsule is accessible when the back flap at the top wall is decoupled with the front cover at each of the side wall extensions while the front cover and the remained of the back cover are coupled together below the hinge.

### BRIEF DESCRIPTION OF THE DRAWINGS

Embodiments of the present principles, having been briefly presented in the Summary and described in greater detail in the Detailed Description, may be understood by reference to the illustrative embodiments of the principles depicted in the appended Drawing. However, the figures provided for in the Drawings illustrate only typical embodiments of the principles and are therefore not to be considered limiting of scope for the principles may admit to other equally effective embodiments.

FIG. 1A provides a schematic representation of an exploded view of a configuration of a first capsule, according to one or more embodiments. FIG. 1B provides a schematic representation of a second exploded view of a configuration of a first capsule, according to one or more embodiments.

FIG. 2B provides several schematic representations of isometric views of a first capsule in a first state, according to one or more embodiments. FIG. 2B provides several schematic representations of isometric views of a first capsule in a second state, according to one or more embodiments.

FIG. 3A provides a schematic representation of a perspective view of a configuration of a front cover of a second capsule, according to one or more embodiments. FIG. 3B provides a schematic representation of a perspective view of a configuration of a back cover of the second capsule, according to one or more embodiments.

FIG. 4A provides a schematic representation of a perspective view of a configuration of the second capsule, according to one or more embodiments. FIG. 4B provides a schematic representation of an exploded view of a configuration of the second capsule, according to one or more embodiments.

In both the Drawing and the Detailed Description, to facilitate understanding identical or similar reference numerals have been used where possible to designate identical elements that are common to the figures. The figures are not drawn to scale and may be simplified for clarity. Elements and features of one embodiment may be beneficially incorporated in other embodiments without further recitation. When a “′” is utilized, this may indicate a that a change of state may have occurred between a first recitation and a second recitation; otherwise, all other attributes are as previously described. Examples of a change in state include, but are not limited to, being in a first position and then a second position, a coupling and then decoupling, a phase change from a solid to a liquid, and so forth, and vice versa. A person of ordinary skill in the art appreciates that comparing the figures and the text of the Drawing and the Detailed Description provides information regarding such a change. Unless stated otherwise, a person of ordinary skill in the art appreciates that such changes in state are typically reversible, for example, an item that is coupled may be decoupled.

In this disclosure, the terms “top”, “bottom”, “side”, “above”, “below”, “up”, “down”, “upward”, “downward”, “horizontal”, “vertical”, and the like do not refer to absolute directions. Instead, these terms refer to directions relative to a nonspecific plane of reference. This non-specific plane of reference may be vertical, horizontal, or other angular orientation.

### DETAILED DESCRIPTION

In the following disclosure, reference may be made to one or more embodiments. However, one of skill in the art appreciates that the disclosure is not limited to any specifically described embodiment. Rather, any combination of features and elements, whether related to different embodiments or not, is contemplated to implement and practice the one or more embodiments provided by the disclosure. Furthermore, although the one or more embodiments presented in the disclosure may achieve certain advantages over other possible solutions, the prior art (if existing), and combinations thereof, whether or not a particular advantage is achieved by a given embodiment is not limited by this disclosure. The aspects, features, embodiments, and advantages provided are merely illustrative, and do not limit the scope of the disclosure. The aspects, features, embodiments, and advantages provided are not considered elements or limitations of the appended claims except where explicitly recited in one or more of the Claims. Likewise, one of skill in the art should not construe a reference to “the disclosure” as a generalization of any disclosed subject matter.

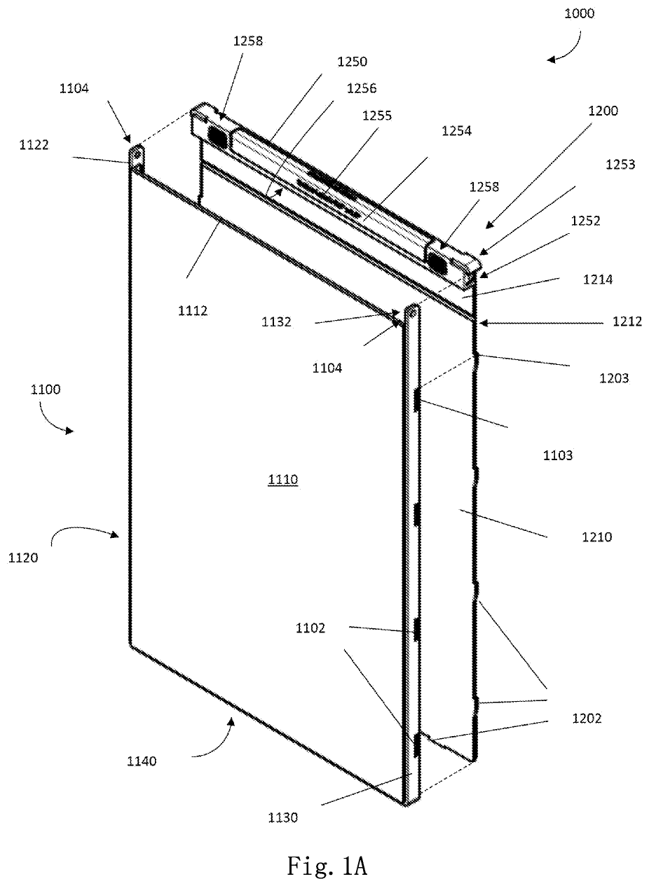

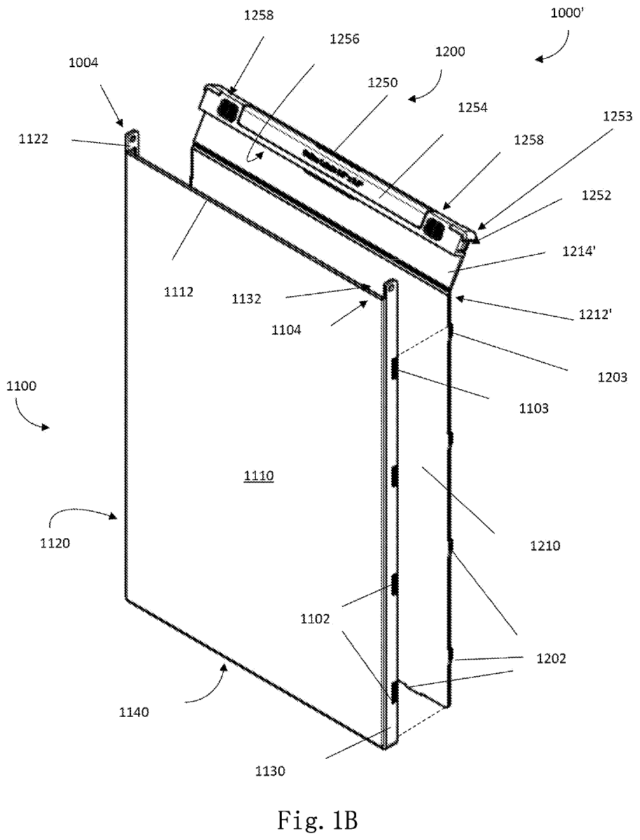

FIG. 1A provides a schematic representation of an exploded view of a configuration of a first capsule. A capsule 1000 is comprised of two components that couple together: a front cover 1100 and a back cover 1200 (partially obscured). The front cover 1100 in FIG. 1A is shown with a front wall 1110 that is connected to or unitarily formed with several walls that project backwards towards the back cover. There are two sidewalls 1120, 1130—one on opposing sides of the front side—and a bottom wall 1140 connected to all three. All four walls in part define the boundaries of the capsule. The two sidewalls 1120, 1130 and the bottom wall 1140 each define one or more voids that are referred to as a front cover coupling slot 1102. Each front cover coupling slot is configured to receive and to retain under friction and tension coupling an associated coupling tab positioned along the back cover. Given that the view for side wall and bottom wall 1140 are obscured, one may assume that one or more front cover coupling slots may be positioned along either or both the side wall, the bottom wall, or both. There is an uppermost coupling slot 1103 on each sidewall 1120, 1130. In the upper part of the front cover 1100, the sidewalls 1120 and 1130 each extend upwards beyond the height of the front wall top edge 1112. These sidewall extensions 1122, 1132, respectively, each define a front cover nipple recess 1104. Each front cover nipple recess is configured to receive and retain under friction and tension an associated coupling nipple positioned along the back flap of the back cover.

The back cover 1200 in FIG. 1A is shown (partially obstructed) with a back wall 1210. As given in FIG. 1A, the back wall 1210 is not coupled to a sidewall or a bottom wall; however, it is coupled to a top wall 1250 positioned at the top of the back wall 1210. The back wall defines one or more back cover outward projecting coupling tabs 1202 along the edges. The cover outward projecting coupling tabs 1202 are present along both the sides and the bottom edges of back cover 1200. Each back cover outward projecting coupling tab 1202 is positioned along the back wall such that the coupling tab 1202 will mate with an associated cover coupling slot defined along the sidewalls or bottom wall on the front cover 1100. An uppermost coupling tab 1203 of the coupling tabs 1202 on the back cover 1200 is paired with an uppermost coupling slot 1103 on the front cover 1100. At a portion of the back wall 1210 that is above the uppermost coupling tab 1203 is configured with a recess for a hinge 1212. Hinge 1212 in FIG. 1A is not shown deflecting the position of back flap 1214, as will be described.

The top wall 1250 is connected to the top of the back wall 1210 and projects forwards from the back wall 1210 towards the front cover 1100. Several features are shown associated with the top wall 1250. The top wall 1250 is configured such that coupling nipple 1252 is positioned under an overhang 1253 that projects outwards from the top wall 1250. Along the top wall front face 1254, visible from a front viewpoint, are thumb grips 1258. For the capsule 1000, there are two thumb grips 1258 positioned proximate to the coupling nipples 1252. A representation of a text label 1255 is provided wrapped around a portion of the top wall 1250, including the top wall front face 1254. The top wall 1250 also has a top wall bottom face 1256 that has an edge configured to match with the front wall top edge 1112, as will be described.

In one or more embodiments, which may be combined with other embodiments, the front cover 1100 defines a front cover nipple recess and the back cover defines an associated coupling nipple.

In one or more embodiments, which may be combined with other embodiments, the front cover 1100 defines a front cover coupling slot and the back cover defines an associated back cover coupling tab 1202. In one or more embodiments, which may be combined with other embodiments, coupling tabs 120 are outward projecting and are planar with the associated wall surface. For example, coupling tabs 1202 associated with the back wall in FIGS. 1A and 1B are coplanar with the back wall.

In one or more embodiments, coupling slots are defined by the sidewalls. In one or more embodiments, coupling slots are defined by the sidewalls and the bottom wall.

In one or more embodiments, the top wall includes an overhang.

FIG. 1B provides a schematic representation of a second exploded view of a configuration of a first capsule. Although the capsule 1000′ is shown in the same exploded state in FIG. 1B as in FIG. 1A, several state changes have occurred that show attributes of the capsule 1000′. Hinge 1212′ is shown in a state of deflection in FIG. 1B as evidenced by the position of back flap 1214′. As a result of the position of hinge 1212′, back flap 1214′ in FIG. 1B is in an ajar or “open” state, which is tilting out-of-plane and in a backwards direction from the remainder of the back wall 1210. The effect of the position of back flap 1214′ and the action of hinge 1212′ will be further described, but one of ordinary skill in the art appreciates and may envision the non-exploded configuration of the capsule 1000′ having an ajar back flap.

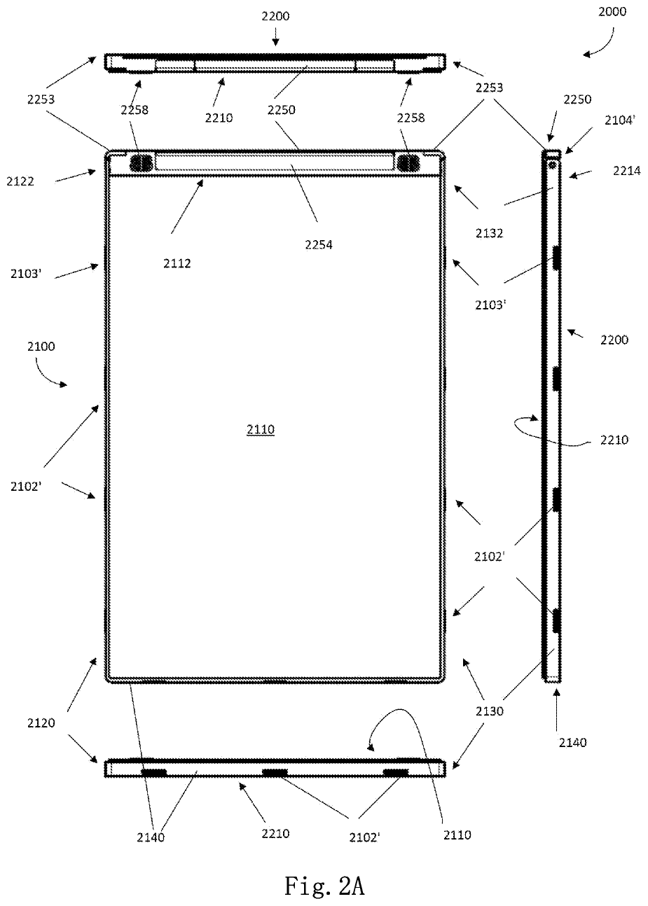

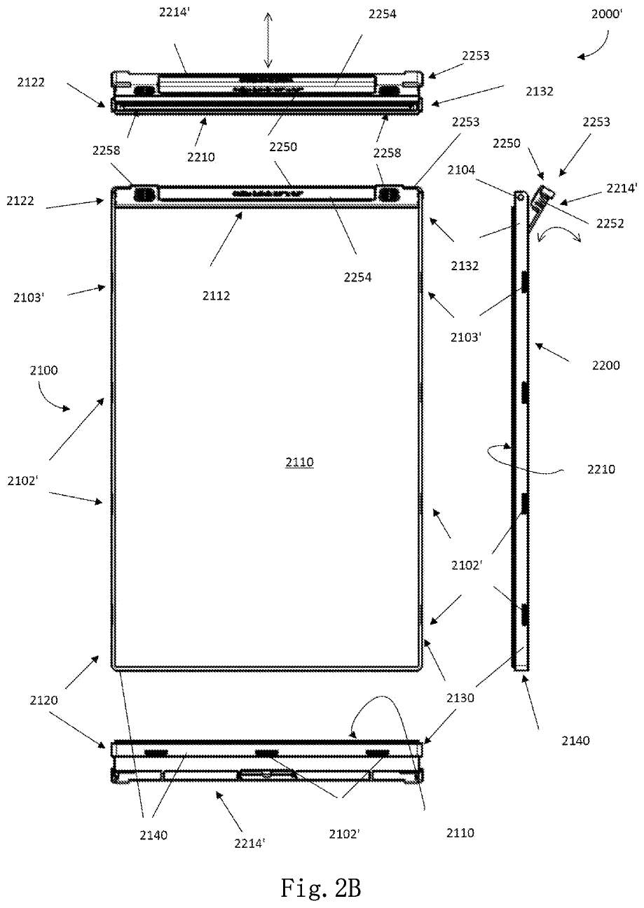

FIG. 2A provides several schematic representations of isometric views of a first capsule in a first state. A capsule 2000, which is similar to the capsule 1000 of FIG. 1A, has several views presented in FIG. 2A. The capsule 2000 is shown with (clockwise from topmost figure) a top, side, bottom, and front views of an assembled capsule. The back cover 2200 is shown coupled with the front cover 2100 to form the capsule 2000. The back cover includes a front wall 2210. The back cover 2200 is configured such that the back cover 2200 fits inside an interior boundary formed by both side walls 2120 and 2130 and the bottom wall 2140. When the back cover 2200 is positioned within the front cover 2100, the back cover 2200 outward projecting coupling tabs may be engaged with the front cover coupling slots to form the capsule 2000.

With the capsule 2000, front cover coupling slots 2102′ are shown engaged with the back cover 2200 outward projecting coupling tabs 1202 (FIG. 1A) and that the front cover 2100 is coupled with the back cover 2200. The configuration and position of each of the defined front cover coupling slots 2102′ and each of the back cover 2200 outward projecting coupling tabs 1202 are such that there is an outward projecting coupling tabs 1202 and a coupling slot 2102′ associated with one another as a mated pair. Each back cover outward projecting coupling tab 1202 is configured to project into and be retained by the associated cover coupling slot 2102′ on the front cover 2100 until the projecting coupling tab is released, thereby maintaining the coupling of the front and the back covers 2100, 2200 together.

As shown in FIG. 2A, the capsule 2000 is in a “closed” state. Although not shown for the sake of clarity, front cover nipple recess 2104′ in this view is engaged with a coupling nipple, such as coupling nipple 1252 of FIGS. 1A and 1B, that is located as part of the back flap 2214. With coupling nipples 1252 engaged with their associated front cover nipple recesses 2104′, the back flap is secured in a closed position. The interior of the capsule 2000 is not accessible because all edges of the back cover 2200 that are not part of the top wall are matched with associated edges within the front cover 2100, such as the interior edges of the sidewalls 2120 and 2130, including the sidewall extensions 2132, and the bottom wall 2140. When the nipples 1252 are coupled, the top wall, such as the top wall 2250, is met with the top edges of the sidewall extensions 2132 through overhangs 2253.

As shown in both the side and front views, when the front and back covers 2100, 2200, are coupled together and the back flap is in a closed state, the configuration of the top wall 2250 and the front wall 2110 are such that the top wall bottom face, such as top wall bottom face 1256 (seen in FIG. 1B), matches and is positioned adjacent on the front cover top edge, such as front cover top edge 2112 from FIG. 2A. The top wall front face, such as top wall front face 2254, and the front wall, such as front wall 2110, also become co-planar in their position as seen from the top, side, and bottom views in FIG. 2A, making a flush, flat front surface. In addition, the overhang, such as overhang 2253, from top wall also provides some directional protection from inadvertent force applied in a downward direction to the tops of sidewall extensions, such as sidewall extensions 2122. This not only protects these parts of the sidewalls but also protects the nipple recess, such as front cover nipple recess 2104′, preventing damage to the latching mechanism of the back flap.

FIG. 2B provides several schematic representations of isometric views of a first capsule in a second state. The capsule 2000′, which is similar to the capsule 1000′ of FIG. 1B (exploded view) and the capsule 2000 (coupled view), has several views presented in FIG. 2B. The capsule 2000′ is also shown with (clockwise from topmost figure) a top, side, bottom, and front views of an assembled capsule but in a different state than in FIG. 2A.

In FIG. 2B, the capsule 2000′ is “open”, that is, the back flap 2214′ is ajar. The back flap 2214′ is able to be in this position because the hinge (not shown) is in a state of deflection and the coupling nipples 2252 are decoupled from the front cover nipple recess 2104. As the hinge is located above the uppermost coupling slot 2103′ and the front cover coupling slots 2102′ remain engaged, the hinge is secured on one side by the coupled back cover 2200 and is free on the other side where the back flap 2214′ is located. The hinge, such as the hinge 1212 of FIGS. 1A and 1212′ of FIG. 1B permit back flap 1214′ to rotate backwards and downward (away from front cover 2100) or forwards and upwards (towards front cover 2100) along the hinge 1212 point of rotation (see double-headed arrow). Once the back flap 2214′ is decoupled at the front cover nipple recess 2104, the back flap 2214′ may be moved in a partially rotational manner with a center at the hinge.

For capsule 2000′, there are two thumb grips 2258 positioned proximate to the coupling nipples 2252 such that when a mild, directional (backwards from front cover) pressure is applied to the thumb grips 2258, the coupling nipples 2252 may slide out of the front cover nipple recess 2104, slightly distort the shape of side wall extensions 2122, and cause the back flap 2214′ to decouple from the front cover 2100 along top wall. Sidewall extensions are sufficiently plastic to resist permanent deformation from such pressure but do permit the passage of the coupling nipples and are configured to return to their shape and position afterwards.

Once the back flap 2214 is ajar, the interior of the capsule 2000 may be accessed to introduce into or to remove an article from the capsule 2000 without decoupling the front cover 2100 from the back cover 2200. The access slot is defined by the ajar back flap 2214 at the hinge, the sidewall extensions 2122, 2232, and the front wall 2110.

To prevent access to the interior of the capsule 2000, the ajar back flap 2214 is moved forward towards the sidewall extensions until the coupling nipples 2252 engage the front cover nipple recesses 2104. Each of the sidewall extensions slightly distort in a sideways direction as the coupling nipples 2252 frictionally move against their interior-facing surfaces until the coupling nipples 2252 and nipple recesses 2104 engage. Upon coupling of the nipples 2252 with the associated nipple recesses 2104, the sidewall extensions move back to their normal, non-disported position. Securing the back flap 2214 and closing the access slot, similar to opening the back flap 2214 and accessing the access slot, may be accomplished with mild hand pressure.

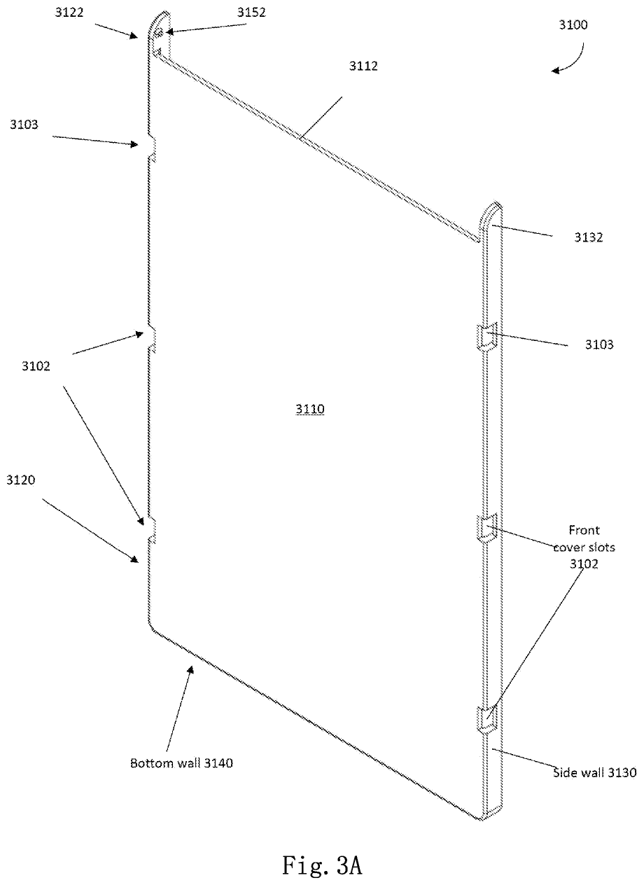

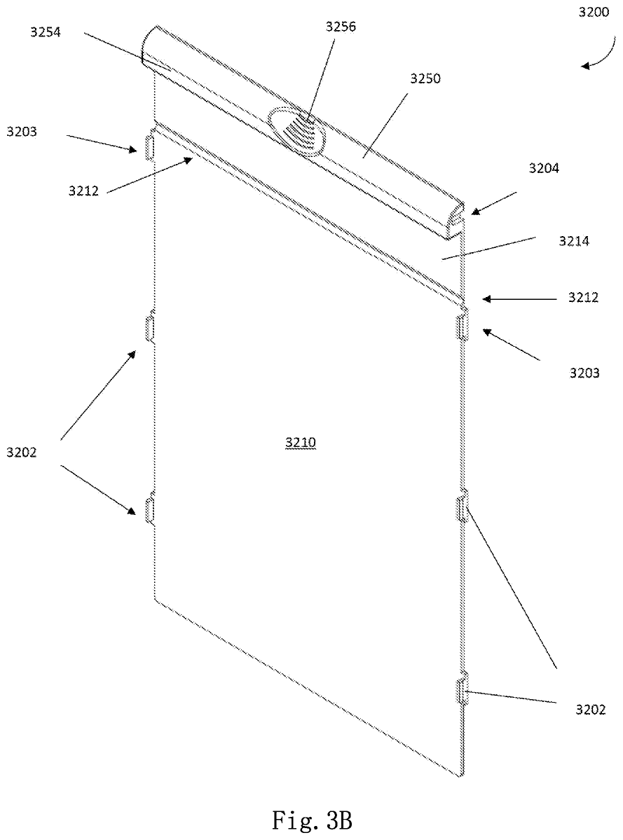

FIG. 3A provides a schematic representation of a perspective view of a configuration of a front cover of a second capsule. The configuration of the front cover 3100 for a second capsule is similar to the configurations of the front covers 1100 and 2100 for the first capsule but for several variations. Comparatively, front coupling slots 3102 of front cover 3100 are defined not only as part of side walls 3120, 3130 but also by front wall 3110, whereas for front covers 1100 and 2100 they were wholly defined by the respective sidewalls. As well, coupling nipples 3152 are part of the sidewall extension 3122, whereas in front covers 1100 and 2100 there were no coupling nipples 3152 but rather front cover nipple recess 1104 and 2104.

In one or more embodiments, which may be combined with other embodiments, the back cover defines a back cover nipple recess 3204 and the front cover 3100 defines an associated coupling nipple 3152. In one or more embodiments, coupling slots 3102 are defined by the side and front walls 3110, 3120.

FIG. 3B provides a schematic representation of a perspective view of a configuration of a back cover 3200 of the second capsule. The configuration of back cover 3200 for a second capsule is similar to the configurations of front covers 1100 and 2100 for the first capsule but for several variations. Front covers 1100 and 2100 were configured with nipple recesses 1104, 2104; however, the nipple recesses 3204 are positioned along the sides of the top wall 3250 for the configuration of back cover 3200. Other notable differences between back cover 3200 and back covers 2200 and 1200 include that there is a single, centralized thumb grip 3256 along top wall 3250, that the top wall 3250 is not configured with overhangs, and that the coupling tabs on the back cover 3200 are forward projecting, such as back cover forward projecting coupling tabs 3202. In the case of the forward versus side-projecting coupling tabs on the back cover, in some configurations this may accommodate a greater interior volume for thicker articles, such as graphic novels or compendium/collections of articles, such as set of articles, in one capsule.

In one or more embodiments, which may be combined with other embodiments, coupling tabs 3202 are non-outward projecting and are not co-planar with the associated wall surface.

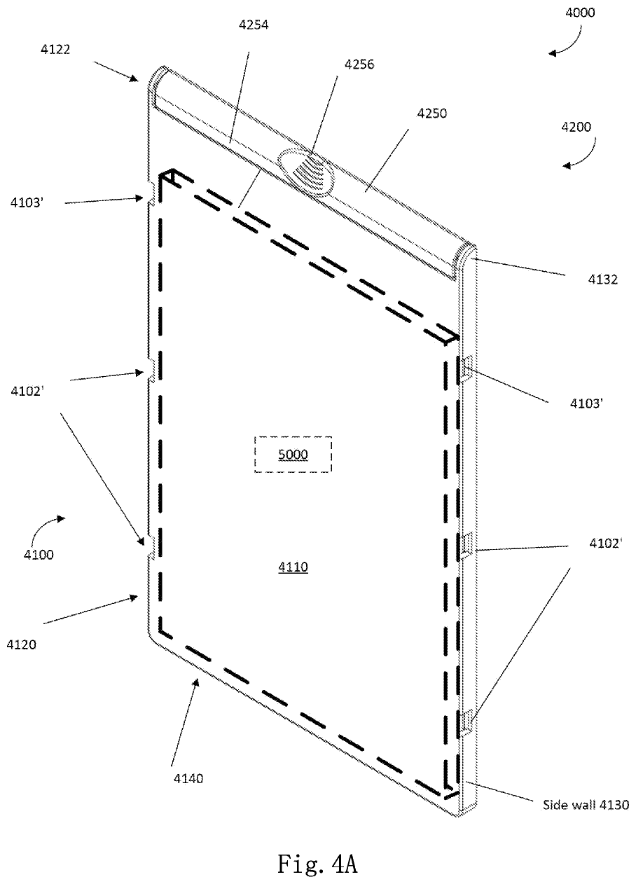

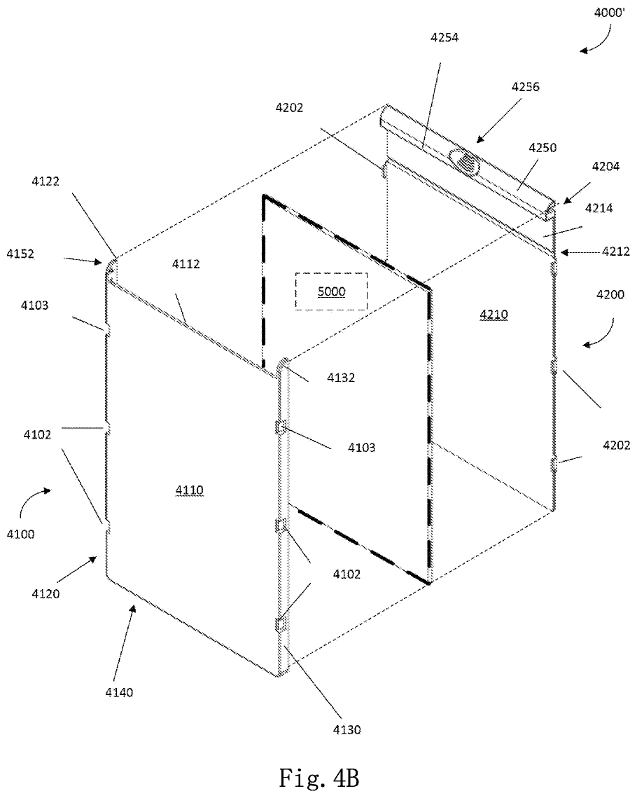

FIG. 4A provides a schematic representation of a perspective view of a configuration of the second capsule. Capsule 4000 is shown in a closed configuration. Capsule 4000 is also shown having an article 5000 (in relief) contained therein. Back cover 4200 is engaged with front cover 4100 by top wall 4250 secured to the side wall extensions 4132 and front cover coupling slots 4102′ engaged with their associated back cover forward projecting coupling tabs (not shown for sake of clarity).

An article, such as article 5000, may be secured within a capsule, such as capsule 4000, in one of two ways. First, as previously described regarding the opening and closing of the back flap 4214 (FIG. 4B), the back flap 4214 may be partially decoupled from the front cover 4100 by using moderate hand pressure to decouple the coupling nipple from the associated coupling recess. After the back flap 4214 is decoupled at the coupling nipples, the back flap 4214 may be rotated backwards and the article 5000 introduced through the previously-described formed access slot. The back flap 4214 may then be recoupled at the coupling nipples. The other manner is to position an article 5000 in between non-coupled front cover, such as front cover 4100, and non-coupled back cover, such as back cover 4200. The front and back covers 4100, 4200 may be coupled with the article 5000 positioned in between by engaging each of the back cover coupling tabs 4202 with their respective front cover coupling slots 4102.

In one or more embodiments, which may be combined with other embodiments, the back cover 4200 defines a back cover coupling slot and the front cover 4100 defines an associated front cover coupling tab. In one or more embodiments, coupling slots are defined by the side, front, and bottom walls.

FIG. 4B provides a schematic representation of an exploded view of a configuration of the second capsule 4000′. Capsule 4000′ in this view shows front cover 4100 decoupled from back cover 4200 but in an exploded view showing appropriate alignment of the coupling nipple 4122 with the back cover nipple recess 4204 and the back cover forward projecting coupling tabs 4202 aligned with their associated front cover coupling slots 4102.

In coupling the front cover 4100 to the back cover 4200, mild hand pressure may be applied to each of the front cover 4100 and the back cover 4200 to permit short-term distortion to the cover bearing the coupling slots to permit the coupling tabs to pass into and couple with the edges of the coupling slots. To decouple the front cover from the back cover, mild hand pressure directed by hand (or via a small tool) may distort the position of the coupling tab 4202 and permit release of the coupling tab 4202 from the coupling slot 4102. In one or more embodiments, which may be combined with other embodiments, the interior edges of the sidewalls and the bottom wall are configured with front cover coupling tabs and the back cover is configured with associated back cover coupling slots such that the front cover and the back cover may couple together.

An article, such as article 5000, may be secured within a capsule, such as capsule 4000, in one of two ways. First, as previously described regarding the opening and closing of the back flap 4212, the back flap 4212 may be partially decoupled from the front cover 4100 by using moderate hand pressure to decouple the coupling nipple 4152 from the associated coupling recess 4202. After the back flap 4214 is decoupled at the coupling nipples 4152, the back flap 4214 may be rotated backwards and the article 5000 introduced through the previously-described formed access slot. The back flap 4214 may then be recoupled at the coupling nipples 4152. The other manner, an article 5000 is positioned in between a non-coupled front cover, such as front cover 4100, and a non-coupled back cover, such as back cover 4200. The front and back covers 4100, 4200 may be coupled with the article positioned in between by engaging each of the back cover coupling tabs with their respective front cover coupling slots.

The capsule 4000′ may be configured to receive, contain, and retain, one or more articles for transport, storage, display, and preservation from the environment. For example, the configuration of the capsule may permit an article, such as a single-issue comic book, to be contained. Typically, a comic book has dimensions that are about 257 millimeters (mm) in height (about 10-⅛ inches) by (x) 168 mm (about 6-⅝ inches) in width by a thickness in a range of from about 1 to 5 mm. An article that is a graphic novel, compendium of individual issues, or “trade paperback” may, for example, have a height in a range of from about 6-⅝ to 6-¾, a width in a range of from about 10.25 to 10-⅜ inches, and a thickness in a range of from about 5 to 30 mm. An article that is in a magazine format comic book may have height in a range of about 11 inches, a width in a range of from about 8-½ to 8-¾ inches, and a thickness in a range of from about 5 to 30 mm. An article that is a golden, silver, or bronze age comic book may have a height in a range of from about 10-⅜ to 10-½ inches, a width in a range of from about 6-¾ to 7-¾ inches, and a thickness in a range of from about 1 to 15 millimeters. An article that is a manga may have a height in a range of from about 7.17 to 8.2 inches, a width in a range of from about 5 to 5.83 inches, and a thickness in a range of from about 5 to 30 mm.

In some examples, the capsule 4000′ is sized to accommodate articles up to 280 cm by 217 cm. The amount of spacing between the edges of the article and the internal edges of the capsule can be selected to limit movement of the article, while still providing ease of retrieval or removal of the article. In some examples, each perimeter edge of the article may be spaced from the internal capsule edges by 1 mm to about 50 mm, such as about 1 mm to about 40 mm, such as about 1 mm to about 30 mm, such as about 1 mm to about 25 mm, such as about 1 mm to about 20 mm, such as about 1 mm to about 15 mm, such as about 1 mm to about 10 mm, such as about 1 mm to 5 mm or about 5 mm to about 10 mm.

An article may be in the form of another type of collectible. For example, an article may be in the form of a bank notes or “paper” currency. As another example, an article may be in the form of another type of collectible, such as a bond or stock certificate, or a magazine, or a photo. In another example, the article is a vinyl record. In the example of a vinyl record, the case may have dimensions of 12.375×12.375 inches and 4 to 6 mm thick (for a 12″ vinyl record). 10.375×10.375 inches and 4 to 6 mm thick may be similarly utilized for a 10″ vinyl record, while 7.375×7.375 inches and 4 to 6 mm thick may be similarly utilized for a 7″ vinyl record.

The components of the capsule comprise one or more materials that have several useful properties. The materials are lightweight-the capsule barely weighs a few ounces. The materials are strong such that the capsule tolerates being transported, stacked, and generally handled roughly. The components of the capsule are rigid but have enough flexibility under mild force, such as that generated by hand, to yield sufficiently to frictionally couple and decouple connectors without breaking the base component. The capsule is overall resilient and long-lived; the capsule is intended to be used (and possibly reused) for years. Useful materials for forming the components of the capsule may include, but are not limited to, polymers, such as thermoplastic polyurethane (TPU); polycarbonate (PC); poly(meth) methacrylate (PMMA); poly(vinyl chloride) (PVC); polystyrene (PS); polyethylene terephthalate glycol (PETG); polypropylene and combinations thereof.

In one or more embodiments, which may be combined with other embodiments, the front cover is comprised of a material that is uniformly substantially transparent. “Transparent” generally means that for a material through which an object is being observed on the opposing side of the material all or almost all of the light passes through the material to the observed object along a single or narrow range of refractive index values that is uniformly distributed throughout the material. For the purposes of this application, a material that is “substantially transparent”, such as a front cover, means that at least 90% of the light that is directed at an object being viewed passes through the material and is not reflected and uniformly passes through the material along a single or narrow refractive index, that is, it generally follows Snell's Law. “Uniform” means that the single or narrow range of refractive index values are the same regardless of viewing perspective using the material. The transparent property for a material results in an observer seeing a sharp contrast in lines and edges, and with an undistorted view of an object positioned on the opposing side of the material through which the object is being viewed. In one or more embodiments, which may be combined with other embodiments, a substantially transparent material permits at least about 90%, such as in a range of at least about 90%, 91%, 92%, 93%, 94%, 95%, 96%, 97%, 98%, 99%, 99.9%, 99.99%, 99.999%, and 99.9999% to about 100% of the light passing through the material.

While the front cover herein is described as being entirely transparent, other alternatives are also contemplated, such as surface texturing, translucent portions (i.e., blurry), or coloring.

Although the front cover may be comprised of material that is uniformly substantially transparent, in one or more embodiments, which may be combined with other embodiments, the transparent material is not colored. That is, a non-colored material does not further comprise a light absorptive element that in response to exposure to broad-spectrum light would produce a hue, tint, tone, or shade of a color. The uniformly substantially transparent material is what is appreciated as being “optically transparent”.

Although the front cover may be comprised of material that is uniformly substantially transparent and not colored, in one or more embodiments, which may be combined with other embodiments, the transparent material is not translucent. “Translucent” generally means that for a material through which an object is being observed on the opposing side of the material all or almost all of the light passes through the material to the observed object; however, there are different refractive index values distributed throughout the material. There is a varying and non-narrow range of refractive index values that cause an observer to have a blurry, non-distinct, and distorted view of an object positioned on the opposing side of the material through which the object is being view. Because light is widely scattered by passing through the material and returns back to the viewer at not the same angle that the light wave entered, a view formed of the object is significantly changed in perspective from the true configuration of the object. In one or more embodiments, which may be combined with other embodiments, a substantially translucent material permits at least about 90%, such as in a range of about 90%, 91%, 92%, 93%, 94%, 95%, 96%, 97%, 98%, 99%, 99.9%, 99.99%, 99.999%, and 99.9999% to about 100% of the light passing through the material.

In one or more embodiments, which may be combined with other embodiments, a sidewall of the front cover is translucent. In one or more embodiments, which may be combined with other embodiments, a back wall of the front cover is translucent.

In one or more embodiments, which may be combined with other embodiments, the back cover comprises the same material that the front cover comprises. In one or more embodiments, which may be combined with other embodiments, the back cover comprises a different material than the front cover comprises. Although the front cover may comprise a material that highlights optical quality, protection of the contained article, and rigidness, the back cover may comprise a material that bears repeated use for securing the back cover to the front cover, including the movement of the back flap, resilience in repeated yet limited movement of the hinge, and permits deflection of the material upon application of a mild force by a user, such as the force applied by a user using a pair of thumbs to couple or decouple the back flap.

In one or more embodiments, which may be combined with other embodiments, the back cover comprises a material that is uniformly substantially transparent. In one or more embodiments, which may be combined with other embodiments, the back cover comprises of a material that is substantially translucent. In one or more embodiments, which may be combined with other embodiments, the back cover comprises of the same material of which the front cover comprises.

In one or more embodiments, which may be combined with other embodiments, the back cover is comprised of a material that is colored. In one or more embodiments, which may be combined with other embodiments, the back cover comprises a single color. In one or more embodiments, which may be combined with other embodiments, the back flap is comprised of a colored material and the remainder of the back cover is comprised of a non-colored material. In some such instances, the back flap and top wall are comprised of the same material as the remaining of the back cover; however, the back flap and top wall portion are dyed and the remainder of the back cover is not dyed.

In some examples, optional additives may be incorporated into the plastic to protect the article, such as UV-A,-B, or -C filtering compounds, or photo-activated tinting.

In one or more embodiments, which may be combined with other embodiments, the back cover is comprised of a material that is semi-transparent, that is, a material that permits light in a range of from about 10% to 90% to pass through the material. In one or more embodiments, which may be combined with other embodiments, the back cover is comprised of a material that is semi-translucent, that is, a material that permits light in a range of from about 10% to 90% to pass through the material. In one or more embodiments, which may be combined with other embodiments, the back cover is comprised of a material that is substantially opaque, that is, a material that permits less than about 10% of light to pass through the material. As may be appreciated by one of ordinary skill in the art, one or more other components of the sensor tag may be configured with configurations utilizing one, some, or all of the unit pouch, the protective barrier, and the sensor unit in the various forms described. As well, alternative configurations of the sensor tag are also contemplated and envisioned.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) can be advantageous and performed as deemed appropriate.

Accordingly, the previously described example implementations do not define or constrain the present disclosure. Other changes, substitutions, and alterations are also possible without departing from the spirit and scope of the present disclosure.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

“Optional” and “optionally” means that the subsequently described material, event, or circumstance may or may not be present or occur. The description includes instances where the material, event, or circumstance occurs and instances where it does not occur.

As used, the term “determining” encompasses a wide variety of actions. For example, “determining” may include calculating, computing, processing, deriving, investigating, looking up (for example, looking up in a table, a database or another data structure), and ascertaining. Also, “determining” may include receiving (for example, receiving information) and accessing (for example, accessing data in a memory). Also, “determining” may include resolving, selecting, choosing, and establishing.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims, except for those in which the claim expressly uses the words ‘means for’ together with an associated function.

The following claims are not intended to be limited to the embodiments provided but rather are to be accorded the full scope consistent with the language of the claims.

1. A capsule comprising
a front cover having a front wall having a front wall top edge, a first side wall having a first side wall extension, a second side wall having a second side wall extension, and a bottom wall, where both the first and the second side walls extensions extend beyond the front wall top edge, and where the front wall is comprised of a uniformly substantially transparent, non-translucent, and non-colored material;
a back cover coupled to the front cover having a back wall and a top wall, where the back wall includes a recess hinge, where a portion of the back wall above a position of the hinge and the top wall are configured as a back flap, and where the coupled front and back covers define a capsule interior;
wherein the front cover and the back cover below the hinge are configured to be coupled together using associated coupling tabs and coupling slots,
wherein the first and the second side wall extensions of the front cover and the top wall of the back flap are configured to be coupled together using a coupling nipple and an associated nipple recess, and
wherein the capsule is configured such that an interior of the capsule is accessible when the top wall of the back flap is decoupled from the first and the second side wall extensions of the front cover while the front cover and a remainder of the back cover are coupled together below the hinge.

2. The capsule of claim 1, wherein the top wall of the back flap defines the coupling nipple and the first and the second side wall extensions of the front cover define the associated nipple recess.

3. The capsule of claim 1, wherein the first and the second side wall extensions of the front cover define the coupling nipple and the top wall of the back flap defines the associated nipple recess.

4. The capsule of claim 1, wherein the top wall further defines an overhang.

5. The capsule of claim 1, wherein the front cover defines along the side and bottom walls coupling slots and the back cover defines associated coupling tabs.

6. The capsule of claim 1, wherein the front cover defines along the side and front walls coupling slots and the back cover defines associated coupling tabs.

7. The capsule of claim 1, wherein the first and the second side walls are translucent.

8. The capsule of claim 1, wherein the bottom wall is translucent.

9. The capsule of claim 1, wherein the back cover is translucent.

10. The capsule of claim 1, wherein the back cover is semi-transparent.

11. The capsule of claim 1, wherein the back cover is opaque.

12. The capsule of claim 1, wherein the back flap is comprised of a colored material and the remainder of the back cover is comprised of a non-colored material.

13. The capsule of claim 1, wherein the front cover and the back cover are comprised of the same material.

14. A capsule comprising
a front cover having a front wall having a front wall top edge, a first side wall having a first side wall extension, a second side wall having a second side wall extension, and a bottom wall, where both the first and the second side walls extensions extend beyond the front wall top edge;
a back cover coupled to the front cover having a back wall and a top wall, where the back wall includes a recess hinge, where a portion of the back wall above a position of the hinge and the top wall are configured as a back flap, and where the coupled front and back covers define a capsule interior;
wherein the front cover and the back cover below the hinge are configured to be coupled together using associated coupling tabs and coupling slots,
wherein the first and the second side wall extensions of the front cover and the top wall of the back flap are configured to be coupled together, and
wherein the capsule is configured such that an interior of the capsule is accessible when the top wall of the back flap is decoupled from the first and the second side wall extensions of the front cover while the front cover and a remainder of the back cover are coupled together below the hinge.

15. The capsule of claim 14, wherein the first and the second side walls are translucent.

16. The capsule of claim 14, wherein the bottom wall is translucent.

17. The capsule of claim 14, wherein the back cover is translucent.

18. The capsule of claim 14, wherein the back cover is semi-transparent.

19. The capsule of claim 14, wherein the back cover is opaque.

20. The capsule of claim 14, wherein the back flap is comprised of a colored material and the remainder of the back cover is comprised of a non-colored material
